(19) United States
(12) Patent Application Publication
(10) Pub. No.: US 2024/0174505 A1
(43) Pub. Date: May 30, 2024

(54) FILLING STATION FOR FILLING A PRESSURIZED GAS TANK

(71) Applicant: L'Air Liquide, Société Anonyme pour I'Exploitation des Procédés Georges Claude, Paris (FR)

(72) Inventor: Stephane DUDRET, Paris (FR)

(21) Appl. No.: 18/521,277

(22) Filed: Nov. 28, 2023

(30) Foreign Application Priority Data
Nov. 28, 2022 (FR) 2212383

(51) Int. Cl. B67D 7/14; G06K 7/10

(52) U.S. Cl. CPC B67D 7/145; G06K 7/10297

(57) ABSTRACT

The invention relates to a filling station including a pressurized fluid source; a fluid transfer pipe including an upstream end connected to the pressurized fluid source and a downstream end; a connection member connected to the downstream end; and a housing for receiving the connection member; the connection member having a passive radio-frequency identification module comprising a first antenna; the housing having an active radio-frequency identification module having a second antenna.

### CROSS REFERENCE TO RELATED APPLICATIONS

This application claims the benefit of priority under 35 U.S.C. § 119 (a) and (b) to French Patent Application No. 2212383, filed Nov. 28, 2022, the entire contents of which are incorporated herein by reference.

### BACKGROUND

The invention relates to a filling station for filling a pressurized gas tank, for example a filling station for filling a pressurized gas tank of a vehicle. The pressurized fluid may be pressurized hydrogen gas, notably serving as an oxidizing gas.

The invention relates more particularly to a filling station for filling a pressurized gas tank comprising:
a pressurized fluid source;
a fluid transfer pipe comprising an upstream end connected to the pressurized fluid source and a downstream end;
a connection member connected to the downstream end;
a control unit configured to order filling with fluid.

Filling stations for filling pressurized gas tanks use connection members (also called “nozzles” or “filling nozzles”) which have to resist high pressure (more than 900 bar, for example) and low temperatures (for example −40° C.). These constraints make these connection members complex and difficult to handle.

In vehicles using a fuel in the form of a pressurized fluid, such as compressed natural gas or liquefied gas, this fuel is stored under pressure in at least one pressurized fluid tank which, whatever material it is composed of, has to be regularly subjected to tests or checks, the aim of which is to verify its state and its resistance to the use pressure.

Filling stations may thus present an obstacle to vehicles equipped with non-compliant tanks being kept on the road by preventing them from being filled at all. Independently, filling stations may exchange data (directly or indirectly) with the vehicle to be filled with pressurized fluid, notably during filling. This is made necessary in order to make it possible to optimize and make safe filling operations, in particular for rapid and/or high-pressure filling operations.

This is particularly relevant when seeking to decrease the time which is necessary for filling, or when seeking to optimize the amount of hydrogen delivered with respect to the physical capacities of the tank, or indeed when seeking to reduce the energy cost of a filling operation.

In the case of communication between the vehicle and the filling station, provision is made, for example, to transfer data such as at least one of: the temperature in the tank, the pressure in the tank, the volume of the tank, the maximum admissible pressure in the tank, the state of connection to the tank. This communication is made possible by integrating, into the filling station, a communication member in order to make it possible to exchange data with the vehicle. This communication member may be in direct communication with the vehicle and/or in indirect communication via a remote server (in this case, the filling station and the vehicle are in communication with the remote server and data are exchanged via the remote server).

In the case of direct communication between the filling station and the vehicle, the communication member may comprise a near-field communication module with an emitter antenna, for example an active radio-frequency identification module such as an NFC module. Such a module generally comprises an antenna which emits a magnetic field, positioned on the connection member. This active communication module is thus arranged to initiate communication with another near-field communication module positioned at the inlet of the tank to be filled so as to make it possible to establish near-field communication between the vehicle and the filling station on the initiative of the connection member, when the connection member is in proximity to the inlet of the tank to be filled or inserted into the inlet of the tank to be filled.

In the case of indirect communication via a remote server, the communication member may comprise a wired or wireless communication interface for exchanging data with a remote server. Although the filling station is able to exchange data with a remote server, it remains preferable for it to be able to identify the vehicle itself before it is filled with pressurized fluid. Such identification may be made by means of the active radio-frequency identification module as described above.

In order to make it possible for the active radio-frequency identification module to be supplied with electrical energy, but also in order to make it possible for the control unit of the filling station to control the active radio-frequency identification module, it is necessary to connect it to the control unit with at least one electrical cable integrated into the transfer pipe. Such an electrical cable is complicated to use and is a source of faults. In addition, supplying electric power poses safety problems in this at-risk area (flammable gas).

### SUMMARY

The present invention aims to remedy these drawbacks effectively by proposing a filling station for filling a pressurized gas, notably pressurized hydrogen gas, tank, comprising:
a pressurized fluid source;
a fluid transfer pipe comprising an upstream end connected to the pressurized fluid source and a downstream end;
a connection member connected to the downstream end;
a control unit configured to order filling with fluid;
a housing for receiving the connection member, the housing notably being stationary, the housing and the connection member being configured to make it possible for the connection member to be removable from the housing, the connection member being configured to be in a first configuration, in which it is received by the housing, and to be in a second configuration, in which it is outside the housing;
the connection member comprising a passive radio-frequency identification module comprising a first antenna, the housing comprising an active radio-frequency identification module comprising a second antenna, the active radio-frequency identification module being configured so that the second antenna generates a magnetic field which is able to supply energy to the passive radio-frequency identification module, when the connection member is in the first configuration.

This makes it possible to improve the reliability of a filling station without affecting the physical safety of the area around which filling takes place, while at the same time improving the safety of the filling operations. Such a connection member may, alternatively, be in near-field communication with, that is to say at a distance of less than a few tens of centimetres or of less than a few tens of millimetres from, the filling station to which it is connected and the vehicle the tank of which has to be filled. This makes it possible to put in place a method for making an operation of filling a pressurized fluid tank safe.

According to one embodiment, the active radio-frequency identification module is configured to make magnetic coupling between the first antenna and the second antenna possible, when the connection member is in the first configuration.

According to one embodiment, the first antenna and the second antenna each comprise at least one turn.

According to one embodiment, the connection member and the housing are configured so that at least one turn of the first antenna extends in the same plane as the plane in which at least one turn of the second antenna extends, when the connection member is in the first configuration.

According to one embodiment, the control unit is configured to control the active radio-frequency identification module so that the active radio-frequency identification module:
detects the presence of the passive radio-frequency identification module when the connection member is in the first configuration;
exchanges data with the passive radio-frequency identification module when the connection member is in the first configuration.

According to one embodiment, the filling station comprises a first communication interface, for example for communicating with a remote server, the control unit being configured to:
generate or receive via the first communication interface, or receive from the passive radio-frequency identification module via the active radio-frequency identification module, at least one first datum, notably an authentication datum or a filling session datum or an encryption datum, the first datum notably being single-use;
control the active radio-frequency identification module so that the active radio-frequency identification module exchanges at least one second datum with the passive radio-frequency identification module, the connection member being in the first configuration, the radio-frequency identification module supplying energy to the passive radio-frequency identification module;
receive authorization to fill the tank, via the first communication interface, prior to the order to fill with fluid.

According to one embodiment, the connection member is configured to be connected in a sealed fashion to an inlet of a pressurized fluid tank to be filled.

The invention further relates to an apparatus comprising a filling station as described above and a vehicle comprising an inlet of a pressurized fluid tank to be filled, the inlet of the pressurized fluid tank comprising a second active radio-frequency identification module comprising a third antenna, the connection member being configured to be in a third configuration, in which it is connected, notably in a removable and sealed fashion, to the inlet of the pressurized fluid tank, the second active radio-frequency identification module being configured so that the third antenna generates a magnetic field which is able to supply energy to the passive radio-frequency identification module, when the connection member is in the third configuration.

According to one embodiment, the third antenna comprises at least one turn, the connection member and the inlet of the pressurized fluid tank being configured so that at least one turn of the first antenna extends in the same plane as the plane in which at least one turn of the third antenna extends, when the connection member is in the third configuration.

According to one embodiment, the vehicle comprises a second control unit configured to control the second active radio-frequency identification module so that the second active radio-frequency identification module:
detects the presence of the passive radio-frequency identification module when the connection member is in the third configuration;
exchanges data with the passive radio-frequency identification module, the connection member being in the third configuration, the second radio-frequency identification module supplying energy to the passive radio-frequency identification module.

According to one embodiment, the vehicle comprises a fourth datum relating to a unique identifier of the vehicle and/or relating to a unique identifier of the tank of the vehicle and/or relating to the integrity of the tank of the vehicle.

The invention further relates to a method for making it safe to fill a pressurized fluid tank using an apparatus comprising a filling station for filling a pressurized fluid tank comprising:
a pressurized fluid source;
a fluid transfer pipe comprising an upstream end connected to the pressurized fluid source and a downstream end;
a connection member connected to the downstream end;
a control unit configured to order filling with fluid;
a housing for receiving the connection member, the housing notably being stationary, the housing and the connection member being configured to make it possible for the connection member to be removable from the housing, the connection member being configured to be in a first configuration, in which it is received by the housing, and to be in a second configuration, in which it is outside the housing;
a first communication interface, for example for communicating with a remote server;
the connection member comprising a passive radio-frequency identification module comprising a first antenna, the housing comprising an active radio-frequency identification module comprising a second antenna, the active radio-frequency identification module being configured so that the second antenna generates a magnetic field which is able to supply energy to the passive radio-frequency identification module, when the connection member is in the first configuration, the apparatus comprising a vehicle comprising an inlet of a pressurized fluid tank to be filled, the inlet of the pressurized fluid tank comprising a second active radio-frequency identification module comprising a third antenna, the connection member being configured to be in a third configuration, in which it is connected, notably in a removable and sealed fashion, to the inlet of the pressurized fluid tank, the second active radio-frequency identification module being configured so that the third antenna generates a magnetic field which is able to supply energy to the passive radio-frequency identification module, when the connection member is in the third configuration; the method comprising the steps of:
   a) generating at least one first datum, notably an authentication datum or a filling session datum or an encryption datum, the first datum notably being single-use, the first datum notably being received by the first communication interface or generated by the control unit or generated by the passive radio-frequency identification module;
   b) exchanging at least one second datum between the active radio-frequency identification module and the passive radio-frequency identification module, the connection member being in the first configuration, the active radio-frequency identification module supplying energy to the passive radio-frequency identification module;
   c) exchanging at least one third datum between the second active radio-frequency identification module and the passive radio-frequency identification module, the connection member being in the third configuration, the second active radio-frequency identification module supplying energy to the passive radio-frequency identification module;
   d) receiving authorization to fill the tank via the first communication interface, notably if the third datum is equal to a predetermined value depending on the first datum and/or on the second datum.

According to one embodiment, the vehicle comprises a fourth datum relating to a unique identifier of the vehicle and/or relating to a unique identifier of the tank of the vehicle and/or relating to the integrity of the tank of the vehicle.

According to one embodiment, the vehicle comprises a second control unit.

According to one embodiment, the method comprises the step of generating a fifth datum as a function of the third datum and of the fourth datum, the fifth datum notably being generated by the second control unit.

According to one embodiment, step d) of receiving authorization to fill the tank via the first communication interface is carried out if the fifth datum is equal to a second predetermined value depending on the fourth datum and/or on the fifth datum.

### BRIEF DESCRIPTION OF THE DRAWINGS

The invention will be understood better from reading the following description and from studying the accompanying figures. These figures are given only to illustrate, and in no way to limit, the invention.

FIG. 1 is a schematic depiction of a station according to the invention;

FIG. 2 is a schematic depiction of an apparatus comprising the station of FIG. 1.

### DETAILED DESCRIPTION OF PREFERRED EMBODIMENTS

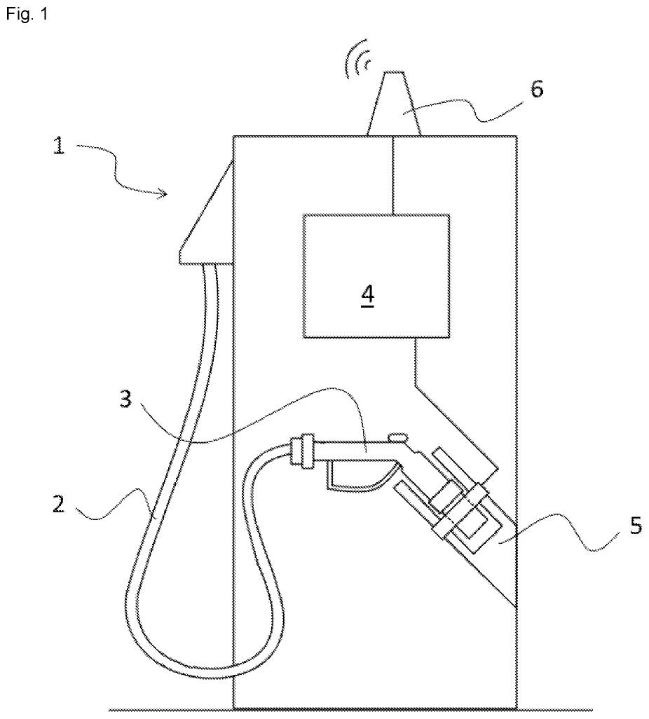

With reference to FIG. 1, a filling station 1 for filling a pressurized fluid, notably pressurized hydrogen gas, tank is depicted.

The filling station 1 comprises:
a pressurized fluid source;
a fluid transfer pipe 2 comprising an upstream end connected to the pressurized fluid source and a downstream end;
a connection member 3 connected to the downstream end, notably a flexible hose;
a control unit 4 configured to order filling with pressurized fluid;
a housing 5 for receiving the connection member.

The housing 5 is stationary. For example, the filling station 1 comprises a distribution terminal and the housing 5 is formed as one with the distribution terminal.

The housing 5 and the connection member 3 are configured to make it possible for the connection member 3 to be removable from the housing 5.

The connection member 3 is configured to be in a first configuration, in which it is received by the housing 5, and to be in a second configuration, in which it is outside the housing 5.

The housing 5 may comprise a sensor for sensing the presence of the connection member 3.

The connection member 3 comprises a passive radio-frequency identification module comprising a first antenna.

The housing 5 comprises an active radio-frequency identification module comprising a second antenna.

The active radio-frequency identification module is configured so that the second antenna generates a magnetic field which is able to supply energy to the passive radio-frequency identification module, when the connection member is in the first configuration.

The active radio-frequency identification module is configured to make magnetic coupling between the first antenna and the second antenna possible, when the connection member is in the first configuration.

The passive radio-frequency identification module may be configured so that magnetic coupling to the second antenna may take place only when the connection member is in the first configuration. In other words, when the connection member 3 leaves the housing 5 and when the distance between the first antenna and the second antenna exceeds a predetermined threshold, coupling between the first antenna and the second antenna is no longer possible. This threshold is, for example, between 10 and 30 centimetres. In a variant, this threshold is between 10 and 30 millimetres.

The passive radio-frequency identification module and the active radio-frequency identification module are each produced in the form of an electronic component, for example of RFID (radio-frequency identification) type or of NFC (near-field communication) type. They make it possible, between them, to exchange data in the near field, that is to say contactlessly and at a distance of at most a few tens of centimetres in the absence of any interference or of any material which may prevent electromagnetic waves from propagating. This distance is, for example, at most 30 centimetres or at most 30 millimetres.

More specifically, the active radio-frequency identification module possesses an energy source making it possible for it to make an electric current flow through the second antenna, which then emits an electromagnetic field playing a triple role when the passive radio-frequency identification module is at a distance which is below the threshold, which is the case when the connection member is in the first configuration:
supplying electrical energy to the passive radio-frequency identification module;
transmitting data to the passive radio-frequency identification module;
receiving data originating from the passive radio-frequency identification module.

The active radio-frequency identification module may comprise a computing unit and/or a memory, notably a non-volatile memory.

Furthermore, the passive radio-frequency identification module is supplied with energy by the electromagnetic field generated by the second antenna. It may therefore be activated and respond to the active radio-frequency identification module only when there is magnetic coupling between the first antenna and the second antenna, and on the initiative of the active radio-frequency identification module.

The passive radio-frequency identification module may comprise a computing unit and/or a memory, notably a non-volatile memory. The computing unit is powered by the electromagnetic field generated by the second antenna. This computing unit may make it possible to perform mathematical operations, notably for cryptographic purposes, for example in order to respond to a request sent by the active radio-frequency identification module. Such a request may serve to carry out a digital signature, data encryption or digital authentication.

The passive radio-frequency identification module may further comprise an electrical energy store, which is powered when there is coupling between the first and the second antenna. Such an electrical energy store remains insufficient to make it possible for the passive radio-frequency identification module to generate a magnetic field in order to initiate communication with the active radio-frequency identification module, but it is sufficient to make it possible to reactivate the computing unit and/or the memory and/or a measurement sensor, even when the connection member is not in the first configuration.

The first antenna and the second antenna each comprise at least one turn.

The connection member 3 and the housing 5 are configured so that at least one turn of the first antenna extends in the same plane as the plane in which at least one turn of the second antenna extends, when the connection member 3 is in the first configuration.

The control unit 4 is configured to control the active radio-frequency identification module so that the active radio-frequency identification module:
detects the presence of the passive radio-frequency identification module when the connection member 3 is in the first configuration;
exchanges data with the passive radio-frequency identification module when the connection member 3 is in the first configuration;
detects the movement of the connection member from the first configuration into the second configuration.

Thus, it is possible to do without a presence sensor in the housing 5, for detecting the insertion and/or withdrawal of the connection member 3 into/from the housing 5.

The filling station 1 comprises a first communication interface 6 for communicating with a remote server or with a vehicle the tank of which is to be filled.

The control unit 4 is configured to:
generate or receive via the first communication interface 6, or receive from the passive radio-frequency identification module via the active radio-frequency identification module, at least one first datum, notably an authentication datum or a filling session datum or an encryption datum, the first datum notably being single-use;
control the active radio-frequency identification module so that the active radio-frequency identification module exchanges at least one second datum with the passive radio-frequency identification module, the connection member being in the first configuration, the radio-frequency identification module supplying energy to the passive radio-frequency identification module;
receive authorization to fill the tank, via the first communication interface 6, prior to the order to fill with fluid.

The connection member 3 is configured to be connected in a sealed fashion to an inlet 7 of a pressurized fluid tank to be filled.

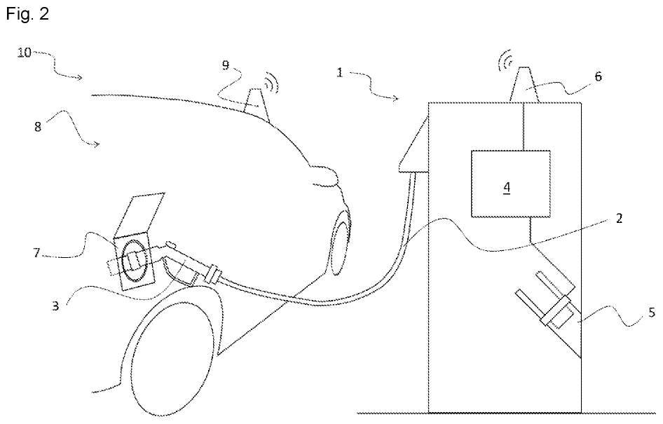

FIG. 2 depicts an apparatus 10 comprising the filling station 1 as described above and a vehicle 8 comprising an inlet 7 of a pressurized fluid tank to be filled.

The inlet 7 of the pressurized fluid tank comprises a second active radio-frequency identification module comprising a third antenna.

The second active radio-frequency identification module is similar, in its operation, to the active radio-frequency identification module of the filling station 1 as described in connection with FIG. 1.

The connection member 3 is configured to be in a third configuration, in which it is connected, notably in a removable and sealed fashion, to the inlet 7 of the pressurized fluid tank, the second active radio-frequency identification module being configured so that the third antenna generates a magnetic field which is able to supply energy to the passive radio-frequency identification module, when the connection member 3 is in the third configuration.

Similar to what was described in connection with FIG. 1, the second active radio-frequency identification module and the passive radio-frequency identification module may exchange data in the near field, that is to say contactlessly and at a distance of at most a few tens of centimetres in the absence of any interference or of any material which may prevent the electromagnetic waves from propagating. This distance is, for example, at most 30 centimetres or at most 30 millimetres.

Similar to what was described in connection with FIG. 1, the passive radio-frequency identification module may be configured so that magnetic coupling to the third antenna may take place only when the connection member 3 is in the third configuration. In other words, when the distance between the third antenna and the second antenna exceeds a second predetermined threshold, coupling between the third antenna and the second antenna is no longer possible. This second threshold is, for example, between 10 and 30 centimetres. In a variant, this second threshold is between 10 and 30 millimetres.

The second active radio-frequency identification module possesses an energy source making it possible for it to make an electric current flow through the third antenna, which then emits an electromagnetic field playing a triple role when the passive radio-frequency identification module is at a distance which is below the second threshold, which is the case when the connection member is in the third configuration:
supplying electrical energy to the passive radio-frequency identification module;
transmitting data to the passive radio-frequency identification module;
receiving data originating from the passive radio-frequency identification module.

The second active radio-frequency identification module may comprise a computing unit and/or a memory, notably a non-volatile memory.

When the connection member 3 is in the third configuration, the passive radio-frequency identification module is supplied with energy by the electromagnetic field generated by the third antenna. In this case, the passive radio-frequency identification module may be activated and respond to the second active radio-frequency identification module only when there is magnetic coupling between the third antenna and the first antenna, and on the initiative of the second active radio-frequency identification module.

The third antenna comprises at least one turn. The connection member 3 and the inlet 7 of the pressurized fluid tank are configured so that at least one turn of the first antenna extends in the same plane as the plane in which at least one turn of the third antenna extends, when the connection member 3 is in the third configuration.

The vehicle 8 comprises a second control unit configured to control the second active radio-frequency identification module so that the second active radio-frequency identification module:
detects the presence of the passive radio-frequency identification module when the connection member 3 is in the third configuration;
exchanges data with the passive radio-frequency identification module, the connection member 3 being in the third configuration, the second radio-frequency identification module supplying energy to the passive radio-frequency identification module.

Such an apparatus may make possible authentication, notably mutual authentication, between a filling station and a vehicle, prior to a filling operation.

This makes it possible to limit the opportunities, for a malicious actor, to fill a fluid tank in conditions which are incompatible with regulations.

The apparatus comprises a remote server which is able to communicate both with the filling station and with the vehicle.

The vehicle 8 comprises a second communication interface 9. This second communication interface 9 makes it possible for the vehicle to communicate with the remote server, either by connecting to the first communication interface 6 or by using a Wi-Fi or GSM or equivalent network.

An authentication method as mentioned above comprises, for example, the following steps:
a) the remote server generates a challenge-response computer datum, comprising a challenge and an expected response;
b) the control unit 4 receives the challenge from the remote server;
c) the control unit 4 transmits the challenge to the passive radio-frequency identification module via the active radio-frequency identification module while the connection member 3 is in the first configuration;
d the second control unit configures the second active radio-frequency identification module so that it supplies energy to the passive radio-frequency identification module and so that it acquires the challenge which is stored in the passive radio-frequency identification module, while the connection member 3 is in the third configuration, that is to say when there is magnetic coupling between the first antenna and the third antenna;
e) the second control unit performs a cryptographic computation on the basis of the challenge in order to determine a second response;
f) the second control unit transmits the second response to the remote server, via the second communication interface 9;
g) the remote server verifies that the second response is legitimate with respect to the expected response;
h) the remote server communicates to the vehicle and/or to the filling station authorization to fill if the response is legitimate or a prohibition on filling if the response is not legitimate.

Steps a) and b) may be repeated periodically, for example every minute. In a variant, steps a) and b) may be initiated upon a request to fill a vehicle being detected or upon the presence of a vehicle in proximity to the filling station being detected.

Furthermore, the authentication method may comprise the following steps, after authorization to fill has been communicated to the vehicle and/or to the filling station:
the second control unit records parameters linked to filling the tank;
the second control unit computes a digital signature linked to the parameters;
the second control unit transmits the digital signature to the remote server and to the passive radio-frequency identification module via the second active radio-frequency identification module; the passive radio-frequency identification module saves the digital signature, notably in the non-volatile memory;
with the connection member being in the first configuration, the active radio-frequency identification module is controlled by the control unit so as to read the digital signature as saved in the passive radio-frequency identification module;
the control unit transmits the digital signature to the remote server;
the remote server compares the digital signature received from the vehicle and the one received from the filling station.

Such an apparatus also makes it possible to encrypt the data transmitted between the remote server and the vehicle and/or between the remote server and the filling station. A public-key algorithm may be implemented. For example, the control unit comprises a station public key and a station private key. The second control unit comprises a vehicle public key and a vehicle private key.

Before a tank is filled, the control unit writes the station public key to the passive radio-frequency identification module, while the connection member is in the first configuration.

When the connection member is in the third configuration, the station public key is transmitted to the second control unit, via the second active radio-frequency identification module.

The second control unit computes a temporary key by encrypting the vehicle public key with the station public key. The second control unit transmits the temporary key to the filling station, via the second communication interface 9.

The control unit 4 computes the vehicle public key by decrypting the temporary key with the station private key.

Thus, the filling station knows the vehicle public key and the vehicle knows the station public key, which makes it possible for the vehicle and for the filling station to encrypt all communication to either. Each message thus exchanged between the vehicle and the filling station may be decrypted using the station private key and the vehicle private key, respectively.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A filling station for filling a pressurized fluid, comprising:
a pressurized fluid source;
a fluid transfer pipe comprising an upstream end connected to the pressurized fluid source and a downstream end;
a connection member connected to the downstream end;
a control unit configured to order filling with fluid;
a housing for receiving the connection member, the housing being stationary, the housing and the connection member being configured to make the connection member removable from the housing, the connection member being configured to be in a first configuration, in which it is received by the housing, and to be in a second configuration, in which it is outside the housing;
the connection member comprising a passive radio-frequency identification module comprising a first antenna, the housing comprising an active radio-frequency identification module comprising a second antenna, the active radio-frequency identification module being configured so that the second antenna generates a magnetic field which is able to supply energy to the passive radio-frequency identification module, when the connection member is in the first configuration.

2. The filling station according to claim 1, the active radio-frequency identification module being configured to make a magnetic coupling between the first antenna and the second antenna, when the connection member is in the first configuration.

3. The filling station according to claim 1, the first antenna and the second antenna each comprising at least one turn.

4. The filling station according to claim 3, the connection member and the housing being configured so that at least one turn of the first antenna extends in the same plane as the plane in which at least one turn of the second antenna extends, when the connection member is in the first configuration.

5. The filling station according to claim 1, the control unit being configured to control the active radio-frequency identification module so that the active radio-frequency identification module:
detects the presence of the passive radio-frequency identification module when the connection member is in the first configuration;
exchanges data with the passive radio-frequency identification module when the connection member is in the first configuration.

6. The filling station according to claim 1, comprising a first communication interface, the control unit being configured to:
generate or receive via the first communication interface, or receive from the passive radio-frequency identification module via the active radio-frequency identification module, at least one first datum, the first datum notably being single-use;
control the active radio-frequency identification module so that the active radio-frequency identification module exchanges at least one second datum with the passive radio-frequency identification module, the connection member being in the first configuration, the radio-frequency identification module supplying energy to the passive radio-frequency identification module;
receive authorization to fill the tank, via the first communication interface, prior to the order to fill with fluid.

7. The filling station according to claim 1, the connection member being configured to be connected in a sealed fashion to an inlet of a pressurized fluid tank to be filled.

8. An apparatus comprising a filling station according to claim 1 and a vehicle comprising an inlet of a pressurized fluid tank to be filled, the inlet of the pressurized fluid tank comprising a second active radio-frequency identification module comprising a third antenna, the connection member being configured to be in a third configuration, in which it is connected to the inlet of the pressurized fluid tank, the second active radio-frequency identification module being configured so that the third antenna generates a magnetic field which is able to supply energy to the passive radio-frequency identification module, when the connection member is in the third configuration.

9. The apparatus according to claim 8, the third antenna comprising at least one turn, the connection member and the inlet of the pressurized fluid tank being configured so that at least one turn of the first antenna extends in the same plane as the plane in which at least one turn of the third antenna extends, when the connection member is in the third configuration.

10. The apparatus according to claim 8, the vehicle comprising a second control unit configured to control the second active radio-frequency identification module so that the second active radio-frequency identification module:
detects the presence of the passive radio-frequency identification module when the connection member is in the third configuration;
exchanges data with the passive radio-frequency identification module, the connection member being in the third configuration, the second radio-frequency identification module supplying energy to the passive radio-frequency identification module.

11. A method for safely filling a pressurized fluid tank using an apparatus comprising a filling station for filling a pressurized fluid tank comprising:
a pressurized fluid source;
a fluid transfer pipe comprising an upstream end connected to the pressurized fluid source and a downstream end;
a connection member connected to the downstream end;
a control unit configured to order filling with fluid;
a housing for receiving the connection member, the housing being stationary, the housing and the connection member being configured to make the connection member removable from the housing, the connection member being configured to be in a first configuration, in which it is received by the housing, and to be in a second configuration, in which it is outside the housing;
a first communication interface;
the connection member comprising a passive radio-frequency identification module comprising a first antenna, the housing comprising an active radio-frequency identification module comprising a second antenna, the active radio-frequency identification module being configured so that the second antenna generates a magnetic field which is able to supply energy to the passive radio-frequency identification module, when the connection member is in the first configuration, the apparatus comprising a vehicle comprising an inlet of a pressurized fluid tank to be filled, the inlet of the pressurized fluid tank comprising a second active radio-frequency identification module comprising a third antenna, the connection member being configured to be in a third configuration, in which it is connected, y in a removable and sealed fashion, to the inlet of the pressurized fluid tank, the second active radio-frequency identification module being configured so that the third antenna generates a magnetic field which is able to supply energy to the passive radio-frequency identification module, when the connection member is in the third configuration; the method comprising the steps of:
a) generating at least one first datum, the first datum being single-use, the first datum y being received by the first communication interface or generated by the control unit or generated by the passive radio-frequency identification module;
b) exchanging at least one second datum between the active radio-frequency identification module and the passive radio-frequency identification module, the connection member being in the first configuration, the active radio-frequency identification module supplying energy to the passive radio-frequency identification module;
c) exchanging at least one third datum between the second active radio-frequency identification module and the passive radio-frequency identification module, the connection member being in the third configuration, the second active radio-frequency identification module supplying energy to the passive radio-frequency identification module;
d) receiving authorization to fill the tank via the first communication interface.
